(19) United States
(12) Patent Application Publication
(10) Pub. No.: US 2010/0150385 A1
(43) Pub. Date: Jun. 17, 2010

(54) HEARING AID WHICH CAN BE WORN IN THE EAR WITH A DIRECTIONAL MICROPHONE

(75) Inventor: Gerhard Sporer, Lauf (DE)

Correspondence Address: LERNER GREENBERG STEMER LLP, P O BOX 2480, HOLLYWOOD, FL, 33022-2480, US

(73) Assignee: SIEMENS AUDIOLOGISCHE TECHNIK GMBH, Erlangen (DE)

(21) Appl. No.: 12/639,332

(22) Filed: Dec. 16, 2009

(30) Foreign Application Priority Data
Dec. 16, 2008 (DE) 10 2008 062 586.8

(51) Int. Cl. H04R 25/00

(52) U.S. Cl. 381/313

(57) ABSTRACT

Feedback should be prevented effectively in a hearing aid which can be worn in the ear. To this end, the arrangement of two microphones, electrically interconnected to form a directional microphone, and a receiver is proposed along a straight line. The directional effect of the directional microphone is set such that, when viewed from the directional microphone, the receiver is arranged in the direction of the lowest sensitivity of the directional microphone. This can effectively suppress feedback even though the hearing aid has a relatively simple design.

### CROSS-REFERENCE TO RELATED APPLICATION

This application claims the priority, under 35 U.S.C. §119, of German application DE 10 2008 062 586.8, filed Dec. 16, 2008; the prior application is herewith incorporated by reference in its entirety.

### BACKGROUND OF THE INVENTION

### Field of the Invention

The invention relates to a hearing aid which can be worn in the ear of a user, containing a housing, a directional microphone and an receiver.

As a result of how they are worn in the ear of a user, there are tight limits on the size of hearing aids which can be worn in the ear. It is also for this reason that the distance between the microphone and the receiver is generally limited to a few centimeters in such a hearing aid. However, this leads to the risk of feedback, particularly when high amplification of an acoustic input signal by the hearing aid is required.

A solution of this problem which works well in practice has yet to be found. Rather, there are tight limits on the maximum amplification of acoustic input signals by a hearing aid which can be worn in the ear, even if the tendency for feedback can be limited by known feedback suppression algorithms or feedback suppression filters.

U.S. Pat. No. 5,201,006 discloses a hearing aid which can be worn in the ear with a main microphone and a plurality of dependent microphones for feedback suppression. The additional microphones are distributed around the outer circumference of the known hearing aid, particularly in the region of the hearing aid lying in the concha and therefore lying outside of the auditory canal. The effects of a housing not completely sealing the auditory canal are only removed in part by this. In order to achieve a high-quality effect, a multiplicity of dependent microphones are required, but these can, if at all, only be housed with great effort in a hearing aid which can be worn in the ear.

Published, non-prosecuted German patent application DE 198 10 043 A1, corresponding to U.S. Pat. No. 6,424,721, discloses a hearing aid which can be worn in the ear with a microphone arm. The overall design is relatively delicate and therefore susceptible to faults.

U.S. Pat. No. 5,757,933 discloses a hearing aid which can be worn in the ear with a plurality of microphones arranged next to one another in a faceplate. This does not afford the possibility of a particularly effective extinction of sound generated by the receiver of the hearing aid.

Published, non-prosecuted German patent application DE 38 40 393 A1 discloses a hearing aid which can be worn in the ear, the housing of which is matched to the individual auditory canal of the user and fits tightly into the auditory canal when being worn.

U.S. Pat. No. 4,528,426 discloses a directional microphone, the housing of which includes acoustically transparent foam.

German utility model DE 299 04 157 U1 discloses a telephone receiver cover made of acoustically transparent foam.

### SUMMARY OF THE INVENTION

It is accordingly an object of the invention to provide a hearing aid which can be worn in the ear with a directional microphone which overcomes the above-mentioned disadvantages of the prior art devices of this general type, which reduces the tendency for feedback in hearing aids which can be worn in the ear.

With the foregoing and other objects in view there is provided, in accordance with the invention a hearing aid to be worn in an ear of a user. The hearing aid contains a housing which, when the hearing aid is worn, has a first housing region facing away from an eardrum of the user, a second housing region, and a fourth housing region facing the eardrum of the user. The first housing region has a first sound entry opening and the fourth housing region has a first sound exit opening. A directional microphone with at least two sound inlet openings is provided. A first sound inlet opening of the sound inlet openings is connected to the first sound entry opening in the first housing region and a second sound inlet opening of the sound inlet openings is disposed within the housing. An receiver is connected to the first sound exit opening and is disposed in the fourth housing region. The housing has at least a second sound entry opening formed between the first sound entry opening and the first sound exit opening. Via the second sound entry opening sound can be supplied to the second sound inlet opening of the directional microphone. When the hearing aid is worn, the housing of the hearing aid does not fit tightly into an auditory canal of the user at least in the second housing region in which the second sound entry opening is disposed. The first sound entry opening and the second sound inlet opening of the directional microphone are disposed at least approximately along a straight line running in a direction of the auditory canal. A direction of a minimum of a directional effect of the directional microphone runs at least substantially in a direction of the straight line pointing to the eardrum.

In a hearing aid, an input transducer records an input signal and converts it into an electrical input signal. At least one microphone is usually used as the input transducer, the microphone recording an acoustic input signal and converting it into an electrical input signal. Modern hearing aids often contain a microphone system with a plurality of microphones in order to obtain reception depending on the direction of incidence of the acoustic signals, that is to say to obtain a certain directional characteristic. However, telephone coils or antennas for recording electromagnetic input signals and converting them into electrical input signals are also conventional input transducers. The input signals converted into electrical input signals by the input transducer are supplied to a signal processing unit for further processing and amplification. The further processing and amplification are performed in order to compensate for the individual loss of hearing of a user and are generally performed as a function of the signal frequency of the input signal. The signal processing unit supplies at the output thereof an electrical output signal which is supplied to the ear of the hearing aid wearer by an output transducer and so the wearer can perceive the output signal as an acoustic signal. Receivers which generate an acoustic output signal are usually used as output transducers. However, output transducers for generating mechanical oscillations are also known; the oscillations directly excite certain parts of the ear, such as the auditory ossicles, so that these oscillate too. Moreover, output transducers are known which directly stimulate the neurons of the ear. A hearing aid furthermore contains a voltage source (battery or accumulator) for the voltage supply of the electronic components. Moreover, operating elements (on/off switch, program selector switch, volume adjuster, etc.) can also be present.

In hearing aids, a distinction is basically made between three designs: behind-the-ear (BTE) hearing aids are worn behind the ear, except for an ear mold located in the ear. In-the-ear (ITE) hearing aids are predominantly located in the concha of the pinna when the hearing aid is worn. Some of them also project into the auditory canal. CIC (completely in the canal) hearing aids are practically invisible from the outside. When used, they are located entirely in the auditory canal.

The method of operation of a directional microphone with two sound inlet openings depends decisively on the position of the two sound inlet openings. In particular, the openings determine the direction of the lowest sensitivity, the so-called notch, of the directional microphone system. According to the invention, the sound inlet openings of the directional microphone and the sound outlet opening of the receiver are arranged at least approximately along a straight line and so the receiver is arranged in the region of the lowest sensitivity of the directional microphone. To this end, a first sound inlet opening of the directional microphone points out of the auditory canal when the hearing aid is worn. By contrast, the second sound inlet opening of the directional microphone is directed toward the eardrum of the user. So that sound impinging on the hearing aid can reach the second sound inlet opening of the directional microphone, the housing of the hearing aid has a circumferential sound entry opening or a plurality of sound entry openings distributed around the circumference of the hearing aid. The entry openings first open into a cavity within the hearing aid, with the second sound inlet opening of the directional microphone likewise opening into this cavity.

The directional microphone preferably contains two electrically interconnected omnidirectional microphones. However, in principle, the invention is not restricted to a microphone system configured in this fashion. By way of example, a gradient microphone with two sound inlet openings could likewise be used.

The invention offers the advantage that only two omnidirectional microphones are required to effectively suppress the sound generated by the receiver of the hearing aid and thus prevent feedback. This also affords the possibility of implementing particularly small designs of hearing aids which can be worn in the ear, e.g. CIC hearing aids, with relatively high amplification.

The housing configuration of a hearing aid according to the invention is advantageously selected such that, at least approximately, the shortest connection between the sound, emanating from the sound exit opening of the hearing aid, and the sound inlet opening of the inner microphone is constant, regardless of the path that the sound takes over the housing. In the case of an at least substantially cylindrical hearing aid, this is achieved by both the sound inlet openings of the microphones and the sound exit opening in the housing of the hearing aid lying on the axis of symmetry of the cylindrical hearing aid. In the case of a housing geometry which is individually fitted to the user, this property can be obtained by an appropriate housing configuration in conjunction with a specific placement of the sound exit opening in the housing. Such optimization is preferably performed with the aid of a computer-aided design, as is conventional in modern mold production.

In order to also effectively suppress the sound which reaches the sound inlet opening of the inner microphone indirectly, for example via reflections off the auditory canal wall, the overall geometry of the hearing aid according to the invention is preferably selected such that the straight line running through the sound inlet openings of the microphones and the sound exit opening of the hearing aid runs at least approximately centrally through the auditory canal.

One embodiment of the hearing aid according to the invention provides for a housing region of the hearing aid, in which the sound entry openings for the second microphone are located, not to fit tightly into the auditory canal while, by contrast, another region of the housing lying closer to the eardrum when the hearing aid is worn fits tightly into the auditory canal and seals the latter. This already significantly reduces the proportion of sound which is emitted by the hearing aid and returns directly to the directional microphone. This specific refinement also contributes to the reduction of feedback.

An alternative embodiment of the invention provides for the hearing aid according to the invention not to seal the auditory canal in any housing region. Thus, the respective hearing aid is designed for an open supply.

The hearing aid is advantageously surrounded by a foam shell in at least one housing section in which the hearing aid is not tightly fitted into the auditory canal. The foam shell is preferably made of a material, in particular an open-pore material, which as it were acts as cerumen protection and prevents the ingress of dirt and cerumen into the sound entry openings of the microphone arranged in the interior of the hearing aid. The foam material surrounding the sound entry openings is advantageously acoustically transparent and so sound can reach the inner microphone of the hearing aid located in the auditory canal from the outside in an almost unimpeded fashion.

Other features which are considered as characteristic for the invention are set forth in the appended claims.

Although the invention is illustrated and described herein as embodied in a hearing aid which can be worn in the ear with a directional microphone, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, illustration of a hearing aid according to the invention located in an auditory canal of a user; and

FIG. 2 is a directional diagram of a directional microphone of the hearing aid.

### DETAILED DESCRIPTION OF THE INVENTION

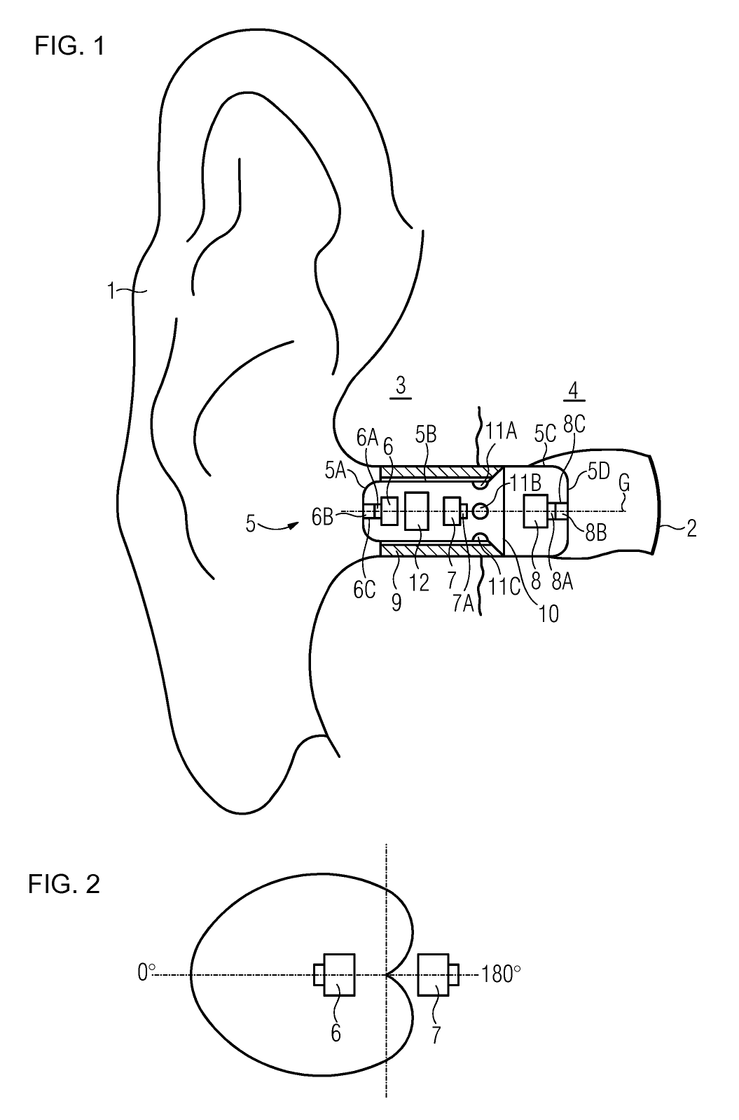

Referring now to the figures of the drawing in detail and first, particularly, to FIG. 1 thereof, there is shown a cross-sectional illustration of a region of a human ear. An external ear 1 with an auditory canal, which is connected thereto and terminated by an eardrum 2, can be recognized. The auditory canal is surrounded by relatively soft tissue in its outer region and by cartilaginous tissue 4 in its region lying further inside.

A CIC (completely in the canal) hearing aid 5 which can be worn in the ear is located in the illustrated auditory canal. The housing of the hearing aid 5 illustrated in an exemplary fashion can be subdivided into four housing regions. A first housing region 5A forms the first housing section of the hearing aid 5 pointing out of the auditory canal. Further inside, this is adjoined by a second, substantially cylindrical housing region 5B, the diameter of which is smaller than the diameter of the auditory canal in this region and which therefore does not fit tightly into the auditory canal. Further inside, this is adjoined by a third housing region 5C which fits tightly into the cartilaginous (bony) region of the auditory canal. The housing is terminated by a fourth housing region 5D facing the eardrum.

The hearing aid 5 contains the two omnidirectional microphones 6 and 7, which are electrically interconnected to form a directional microphone 6, 7, for recording acoustic input signals and converting them into electrical input signals. The electrical input signals are supplied to a signal processing unit 12 which processes and amplifies the electrical input signals. Finally, this results in an electrical output signal which is converted into an acoustic output signal by an receiver 8 and is supplied to the ear of the user via a sound outlet opening 8A in the receiver 8 and a sound canal 8C which opens in a sound exit opening 8B in the hearing aid housing.

A sound entry opening 6B is located approximately in the center of the first housing region 5A so that sound can reach the sound inlet opening 6A of the microphone 6, with there being a sound tube 6C between the sound entry opening 6B in the housing and the sound inlet opening 6A of the microphone 6. The second microphone 7 of the directional microphone 6, 7 is, unconventionally for ITE hearing aids, located at a position farther in the interior of the hearing aid 5. So that sound supplied to the ear from the outside can also reach this microphone 7, a plurality of second sound entry openings 11A, 11B, 11C etc. are distributed over the circumference of the second housing region 5B. In the process, the “internal” microphone 7 is positioned such that the distance between the sound inlet opening 7A of the microphone 7 and the second sound entry openings 11A, 11B, 11C etc. is approximately equal. In the exemplary embodiment, the sound inlet opening 7A and the sound entry openings 11A, 11B, 11C etc. open into a cavity of the hearing aid 5. However, individual sound channels (not illustrated) can also lead from the individual second sound entry openings 11A, 11B, 11C etc. to the sound inlet opening 7A of the microphone 7. In the exemplary embodiment, the cavity is separated from the region in which the receiver 8 is located by a partition 10.

It can be gathered from FIG. 1 that the sound entry opening 6B lies in the first housing region 5A of the hearing aid 5; the sound inlet opening 6A of the microphone 6, the sound inlet opening 7A of the microphone 7 and the sound exit opening 8B of the hearing aid 5 lie approximately on a straight line G which in turn runs at least approximately in the center of the auditory canal.

The directional characteristic preset for the directional microphone 6, 7 is illustrated in FIG. 2. By way of example, such a directional characteristic can be obtained by delaying the microphone signal generated by the microphone 7 and subtracting it from the microphone signal from the microphone 6 when the two microphones 6 and 7 are electronically interconnected. FIG. 2 shows that the direction of the highest sensitivity of the directional microphone 6, 7 points out of the auditory canal and the direction of the lowest sensitivity (notch) points in the direction of the sound exit opening 8B. As a result of this, an optimal reception of the sound entering the auditory canal from the outside is achieved, in conjunction with the largest possible suppression by the directional microphone 6, 7 of the sound generated by the receiver 8.

Advantageously, the housing geometry of the hearing aid 5 is configured such that there is, at least substantially, no difference in the shortest path for the sound generated by the receiver 8 from the sound exit opening 8B to the sound inlet opening 7A of the microphone 7 via the third housing region 5C and the second sound entry openings 11A, 11B, 11C etc., regardless of where the sound propagates over the third housing region 5C. These conditions can already be obtained during the computer-aided design of the housing mold of the hearing aid 5 fitted to the individual auditory canal of the user. Overall, this arrangement offers the advantage that the directional microphone constructed from only two omnidirectional microphones 6 and 7 can already achieve extensive suppression of the sound generated by the receiver 8. This largely prevents feedback, even in the case of large amplification of a sound signal entering the hearing aid 5.

In the hearing aid 5 according to the exemplary embodiment, the second housing region 5B is surrounded by acoustically transparent foam 9. The foam 9 also covers the second sound entry openings 11A, 11B, 11C etc., as a result of which the ingress of cerumen into the hearing aid 5 is prevented. The foam 9 surrounding the second housing region 5B in a shell-like fashion is advantageously connected to the hearing aid 5 in a detachable fashion, and therefore, if need be, it can easily be replaced.

It is a further characteristic of the hearing aid 5 according to the exemplary embodiment that it is configured such that the third housing region 5C fits tightly in the cartilaginous or bony region 4 of the auditory canal. As a result, the sound reaching the microphones 6 and 7 which was generated by the receiver 8 is already significantly damped. This also contributes to the increase in the maximum amplification that can be attained by the hearing aid 5.

1. A hearing aid to be worn in an ear of a user, the hearing aid comprising:
a housing which, when the hearing aid is worn, has a first housing region facing away from an eardrum of the user, a second housing region, and a fourth housing region facing the eardrum of the user, said first housing region having a first sound entry opening formed therein, said fourth housing region having a first sound exit opening formed therein;
a directional microphone with at least two sound inlet openings, a first sound inlet opening of said sound inlet openings is connected to said first sound entry opening in said first housing region and a second sound inlet opening of said sound inlet openings is disposed within said housing;
a receiver connected to said first sound exit opening and disposed in said fourth housing region;
said housing having at least a second sound entry opening formed therein between said first sound entry opening and said first sound exit opening, by means of said second sound entry opening sound can be supplied to said second sound inlet opening of said directional microphone;
when the hearing aid is worn, said housing of the hearing aid does not fit tightly into an auditory canal of the user at least in said second housing region in which said second sound entry opening is disposed;
said first sound entry opening and said second sound inlet opening of said directional microphone are disposed at least approximately along a straight line running in a direction of the auditory canal; and
a direction of a minimum of a directional effect of said directional microphone runs at least substantially in a direction of the straight line pointing to the eardrum.

2. The hearing aid according to claim 1, wherein, when the hearing aid is worn, the straight line runs at least approximately centrally through the auditory canal.

3. The hearing aid according to claim 1, wherein said first sound exit opening is disposed at least approximately on the straight line.

4. The hearing aid according to claim 1, wherein, when the hearing aid is worn, said housing does not fit tightly into the auditory canal in said first housing region and in said second housing region.

5. The hearing aid according to claim 1, wherein said housing has a third housing region and the hearing aid fits tightly into the auditory canal via said third housing region.

6. The hearing aid according to claim 5, wherein, when the hearing aid is worn, said tightly fitting third housing region is fitted in a bony section of the auditory canal.

7. The hearing aid according to claim 1, wherein the hearing aid is configured for an open supply of the user.

8. The hearing aid according to claim 1, wherein said directional microphone is constructed from at least two electrically interconnected omnidirectional microphones.

9. The hearing aid according to claim 1, wherein said second sound entry opening is one of a plurality of second sound entry openings distributed over a circumference of said housing.

10. The hearing aid according to claim 1, wherein said second sound entry opening runs around said housing in at least a substantially annular fashion.

11. The hearing aid according to claim 1, further comprising a cerumen protection device, said second sound entry opening is provided with said cerumen protection device.

12. The hearing aid according to claim 1, further comprising a substantially acoustically transparent foam, said housing, at least in said second housing region, is surrounded by said substantially acoustically transparent foam.
